(19) United States
(12) Patent Application Publication
(10) Pub. No.: US 2026/0088949 A1
(43) Pub. Date: Mar. 26, 2026

(54) METHOD AND APPARATUS FOR DETERMINING UE'S POSITION

(71) Applicant: LENOVO (BEIJING) LIMITED, Beijing (CN)

(72) Inventors: Hongmei LIU, Beijing (CN); Yuantao ZHANG, Beijing (CN); Zhi YAN, Beijing (CN); Ruixiang MA, Beijing (CN); Haiming WANG, Beijing (CN)

(21) Appl. No.: 19/110,757

(22) PCT Filed: Sep. 29, 2022
(86) PCT No.: PCT/CN2022/122666

§ 371 Date: Mar. 11, 2025

(51) Int. Cl. H04L 5/00; H04L 27/26

(52) U.S. Cl. CPC H04L 5/0044; H04L 27/261

(57) ABSTRACT

A method and apparatus for determining UE's position are provided. The method may be performed by a UE. The method includes receiving a first signal indicating at least one of: a first DL RSs at multiple time instances, a second group of UL RSs at multiple time instances, or a third group of UL transmissions at multiple time instances upon receptions of a fourth group of DL transmissions at multiple time instances; receiving a second signal indicating to report at least one of: a first value associated with reception time instances of the first group of DL RSs, a second value associated with transmission time instances of the second group of UL RSs, or a third value associated with transmission time instances of the third group of UL transmissions; and reporting at least one of the first value, the second value, or the third value or determine the uplink transmission time instances for the second set of UL RS or for the third set of UL transmission.

### TECHNICAL FIELD

Embodiments of the present disclosure generally relate to wireless communication technology, especially to a method and apparatus for determining a UE's position in a non-terrestrial networks (NTN).

### BACKGROUND

Non-terrestrial networks (e.g., networks using satellites) may play an important part in enabling communication in places where terrestrial mobile telephony is unviable. NTN services include broadcast applications (e.g., television) and emergency applications for offshore workplaces (e.g., offshore oil platforms, offshore wind power platforms, and shipping). NTN services work in the places where terrestrial networks and land-based communication systems are not accessible. Further, NTN services augment legacy terrestrial network services.

In NTN, a High Altitude Platform Station (HAPS) may refer to airborne vehicle embarking the NTN payload placed at an altitude between 8 and 50 km. The satellite in NTN can be a geostationary earth orbiting (GEO) satellite with fixed location with respect to the Earth, or a low earth orbiting (LEO) satellite orbiting around the Earth.

### SUMMARY OF THE APPLICATION

In legacy networks or terrestrial networks, 3 or 4 transmission and reception points (TRPs) can transmit or receive signal simultaneously for positioning a UE or a device. However, in NTN, positioning based on a single satellite at different time instances may have higher priority. In legacy networks, the TRP and the gNB (next generation Node B) are at same location. However, in NTN transparent payload, the satellite is designed to forward DL/UL signal. In legacy networks, the timing advance (TA) may be small and may be configured or determined by the gNB. However, in NTN network, the TA adopted by UE may be determined based on a common TA indicated by the gNB, and the UE specific TA may be calculated by itself based on the satellite's position and the UE's position.

The present disclosure provides novel methods and apparatuses for determining and verifying a UE's position in an NTN.

Some embodiments of the present disclosure provide a method performed by a user equipment (UE). The method comprises: receiving a first signal indicating at least one of: a first group of downlink (DL) reference signals (RSS) at multiple time instances, a second group of uplink (UL) RSs at multiple time instances, or a third group of UL transmissions upon receptions of a fourth group of DL transmissions at multiple time instances; receiving a second signal indicating to report at least one of: a first value associated with reception time instances of the first group of DL RSs, a second value associated with transmission time instances of the second group of UL RSs, or a third value associated with transmission time instances of the third group of UL transmission; and reporting at least one of the first value, the second value, or the third value or determining the UL transmission time instances for the second group of UL RS or for the third group of UL transmission.

Some embodiments of the present disclosure provide a method performed by a first base station (BS). The method comprises: transmitting a first signal indicating at least one of: a first group of downlink (DL) reference signals (RSs) at multiple time instances, a second group of uplink (UL) RSs at multiple time instances, or a third group of UL transmissions at multiple time instances upon reception of a fourth group of DL transmissions at multiple time instances; transmitting a second signal indicating to report at least one of: a first value associated with reception time instances of the first group of DL RSs, a second value associated with transmission time instances of the second group of UL RSs, or a third value associated with transmission time instances of the third group of UL transmissions; and receiving from another apparatus at least one of the first value, the second value, or the third value, or determine the uplink reception time instances for the second group of UL RSs or for the third group of UL transmissions.

Some embodiments of the present disclosure also provide a user equipment (UE), comprising: at least one processor; and at least one transceiver coupled to the at least one processor. The at least one processor is configured to: receive a first signal indicating at least one of: a first group of downlink (DL) reference signals (RSs) at multiple time instances, a second group of uplink (UL) RSs at multiple time instances, or a third group of UL transmission at multiple time instances upon receptions of a fourth group of DL transmissions at multiple time instances; receive a second signal indicating to report at least one of: a first value associated with reception time instances of the first group of DL RSs, a second value associated with transmission time instances of the second group of UL RSs, or a third value associated with transmission time instances of the third group of UL transmission; and report at least one of the first value, the second value, or the third value or determine the UL transmission time instances for the second group of UL RS or for the third group of UL transmission.

Some embodiments of the present disclosure also provide a first base station (BS), comprising: at least one processor; and at least one transceiver coupled to the at least one processor. The at least one processor is configured to: transmit a first signal indicating at least one of: a first group of downlink (DL) reference signals (RSs) at multiple time instances, a second group of uplink (UL) RSs at multiple time instances, or a third group of UL transmissions at multiple time instances upon reception of a fourth group of DL transmissions at multiple time instances; transmit a second signal indicating to report at least one of: a first value associated with reception time instances of the first group of DL RSs, a second value associated with transmission time instances of the second group of UL RSs, or a third value associated with transmission time instances of the third group of UL transmissions; and receive from another apparatus at least one of the first value, the second value, or the third value, or determine the uplink reception time instances for the second group of UL RSs or for the third group of UL transmissions.

Embodiments of the present disclosure provide a technical solution for determining and verifying a UE's position in an NTN. Accordingly, embodiments of the present disclosure can have more accurate position or location information for UEs in an NTN.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 is a schematic diagram illustrating an exemplary wireless communication system according to some embodiments of the present disclosure.

FIG. 2 is a schematic diagram illustrating transmissions of a downlink (DL) time difference of arrival (TDOA) scheme according to some embodiments of the present disclosure.

FIG. 3A is a schematic diagram illustrating a group of DL reference signals (RSs) according to some embodiments of the present disclosure.

FIGS. 3B and 3C are schematic diagrams illustrating determinations of reference sources according to some embodiments of the present disclosure.

FIG. 4 is a schematic diagram illustrating transmissions of an uplink (UL) TDOA scheme according to some embodiments of the present disclosure.

FIG. 5A is a schematic diagram illustrating a group of UL RSs according to some embodiments of the present disclosure.

FIGS. 5B and 5C are schematic diagrams illustrating determination of UL differences of transmission (Tx) time instances according to some embodiments of the present disclosure.

FIG. 6 is a schematic diagram illustrating transmissions of a multi-round trip time (multi-RTT) scheme according to some embodiments of the present disclosure.

FIG. 7 is a schematic diagram illustrating a multi-round trip time (multi-RTT) scheme according to some embodiments of the present disclosure.

FIG. 8 is a flowchart of a method according to some embodiments of the present disclosure.

FIG. 9 is a flowchart of another method according to some embodiments of the present disclosure.

FIG. 10 is a simplified block diagram of an apparatus for communication according to some embodiments of the present disclosure.

### DETAILED DESCRIPTION

The detailed description of the appended drawings is intended as a description of the currently preferred embodiments of the present disclosure and is not intended to represent the only form in which the present disclosure may be practiced. It is to be understood that the same or equivalent functions may be accomplished by different embodiments that are intended to be encompassed within the spirit and scope of the present disclosure.

Also, the use of the expression “A and/or B” means any one of the following: “A” alone or “B” alone; or both “A” and “B” together.

Reference will now be made in detail to some embodiments of the present disclosure, examples of which are illustrated in the accompanying drawings. To facilitate understanding, embodiments are provided under specific network architecture and new service scenarios, such as 3GPP 5G New Radio (NR), 3GPP long-term evolution (LTE) Release 8 and so on. Persons skilled in the art know very well that, with the development of network architecture and new service scenarios, the embodiments in the present disclosure are also applicable to other similar technical problems.

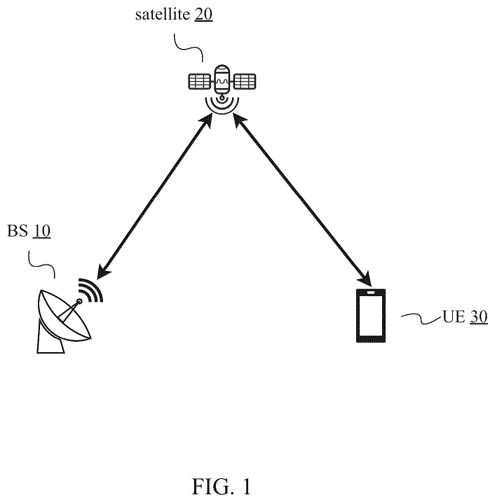

FIG. 1 is a schematic diagram illustrating an exemplary wireless communication system according to some embodiments of the present disclosure.

FIG. 1 shows communications between the user equipment (UE) 30 and the base station (BS) 10 (or gNB). FIG. 1 shows the BS 10, the satellite 20, and the UE 30 for illustrative purpose. The UE 30 may be under the coverage of the satellite 20. As shown in FIG. 1, the BS 10 may be in communication with the UE 30.

For example, the wireless communication system in FIG. 1 may be compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G NR network, a satellite communications network, a non-terrestrial network, a high altitude platform network, and/or other communications networks. In some embodiments, the wireless communication system in FIG. 1 may be compatible with NB-IoT/eMTC for NTN.

In some embodiments, the BS 10 may be referred to as a NodeB, a base unit, a base, an access point, an access terminal, a macro cell, an enhanced Node B (eNB), a gNB, a Home Node-B, a relay node, a device, a remote unit, or by other terminology used in the art. A BS may be distributed over a geographic region. Generally, a BS is a part of a radio access network that may include one or more controllers communicably coupled to one or more corresponding core networks. In some embodiments, the satellite 20 may be a geostationary earth orbiting (GEO) satellite with fixed location with respect to the Earth, or a low earth orbiting (LEO) satellite orbiting around the Earth.

The UE 30 may include computing devices such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to an embodiment of the present disclosure, the UE 30 may include a portable wireless communication device, a smart phone, a cellular telephone, a flip phone, a device having a subscriber identity module, a personal computer, a selective call receiver, or any other device capable of transmitting and receiving communication signals on a wireless network. In some embodiments, the UE 30 may include wearable devices, such as smart watches, fitness bands, optical head-mounted displays, or the like. Moreover, the UE 30 may be referred to as a subscriber unit, a mobile, a mobile station, a user, a terminal, a mobile terminal, a wireless terminal, a fixed terminal, a subscriber station, a user terminal, or a device, or described with other terminology used in the art.

The present disclosure defines a network based solution to verify the position information (or location information) reported by the UE. The verification may be performed independently from the position information reported by the UE.

The UE position information may be considered as being verified if the difference between the UE position reported by the UE and the network-based assessment is within 5-10 km (similar to terrestrial network macro cell size). The UE position information enables and facilitates country discrimination and selection of a core network in order to support all the regulatory services (e.g. emergency calls, lawful intercepts, public warning, charging, and billing).

The solutions provided in the present disclosure neither impact the latency of the targeted services nor infringe privacy requirements for the UE position.

The study in radio access networks (e.g., RAN1, RAN2, and RAN3, which study and evaluate solutions to verify UE reported position information, considers the following aspects. The scenario of single satellite (or HAPS) in the view of the UE at a time would be considered with higher priority. Multiple satellites (or HAPSs) in the view of the UE would be considered if time allows. It is assumed that the UE is attached to a network (so that its context has been set up in the network) for the purpose of positioning. Different solutions or positioning methods for the non-geostationary orbit (NGSO), the geostationary (GSO) or HAPS are not precluded. When the solutions based on positioning methods are considered, the present 3GPP defined radio access technology (RAT) dependent positioning methods defined by 3GPP shall be considered as baseline, and other methods may not precluded. The solutions using present NG-RAN (next generation-radio access network) architectures and procedures would be considered.

Some 3GPP defined RAT dependent positioning methods may be considered as starting points for the study on the network-verified UE position in case of the NGSO-based NTN deployment. The 3GPP defined RAT dependent positioning methods include: multi-RTT schemes, DL-TDOA schemes, and UL-TDOA schemes. Other positioning methods (e.g., angle of arrival-based methods) are not precluded.

Some RAT dependent positioning schemes are disclosed as follows. In the DL TDOA scheme, the UE's position would be obtained based on the differences of the reception (Rx) time instances of the signals from 3 pairs of TRPs (e.g., [TRP#0, TRP#1], [TRP#0, TRP#2], and [TRP#0, TRP#3]). In the UL TDOA scheme, the UE transmits of sounding reference signals (SRSs) to 4 TPRs, and the gNB measures the differences of the Rx time instances of the signals from 3 pairs of TRPs (e.g., [TRP#0, TRP#1], [TRP#0, TRP#2], and [TRP#0, TRP#3]) so as to obtain or determine the UE's position. In the multi-RTT scheme, UE transmits a UL signal upon reception of a DL signal; the gNB can determine the RTT based on the DL Tx time instance and UL Rx time instance at the gNB side; and the UE may reported to the gNB the difference of the DL Rx time instance and the UL Tx time instance at the UE side.

In DL angle of departure (DL AoD) scheme, the UE measures and/or reports DL Tx angle/beam; the gNB determines the UE's position based on the measurement and/or report of DL Tx angle/beam; and reporting the reference signal reception power of each beam may be necessary. In the UL angle of arrival (UL AOA) scheme, the UE transmits sounding reference signals (SRSs); and gNB measures the reception angle of the SRS and determines the UE's position. In the enhanced cell ID (E-CID) scheme, the UE reports the reference signal reception power (RSRP) for multiple cells; the serving cell would be identified accordingly; and UE position is determined to be within the cell coverage. In the carrier phase based scheme, the UE reports the Rx time instance (in the time domain) based on the carrier phase detection; the UE's positions is determined based on the reported Rx time instances; and the accuracy of the E-CID scheme is improved with respect to TDOA schemes. In NR release 17, measurements and reports for different paths/different branches may be introduced to further improve the positioning accuracy.

Some positioning methods in Beidou or GPS are disclosed as follows. The first generation Beidou adopts a multi-RTT based scheme for GEO satellites. The second generation Beidou or GPS adopt a DL TDOA scheme and an UL TDOA scheme. The nearest generation Beidou/GPS adopts carrier phased based scheme to further increase positioning accuracy.

### Embodiment 1: DL TDOA

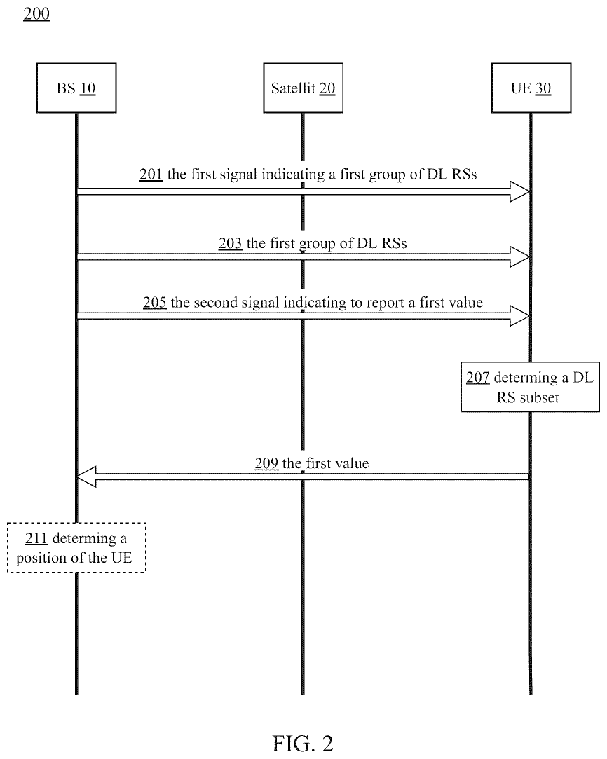

FIG. 2 is a schematic diagram 200 illustrating transmissions of a DL TDOA scheme according to some embodiments of the present disclosure. In the schematic diagram of a DL TDOA scheme, the BS 10, the satellite 20, and the UE 30 may be involved. The DL TDOA scheme provided in the present disclosure may be for the scenario with a single satellite. In some embodiments, the DL TDOA scheme provided in the present disclosure may be for the scenario with multiple satellites.

The schematic diagram 200 includes a plurality of operations. In operation 201, the BS 10 may transmit a first signal to the UE 30 through the satellite 20. In the operation 201, the first signal indicates a group of DL RSs at multiple time instances. The BS 10 may use the first signal to notify the UE 30 that the group of DL RSs may be transmitted. In some embodiments, the BS 10 may use the first signal to notify the UE 30 that the BS 10 may determine or verify the position of the UE 30 based on DL RSs. When the UE 30 receives the first signal, the UE 30 would be ready to receive a group of DL RSs.

In operation 203, the BS 10 may transmit a group of DL RSs to the UE 30 through the satellite 20. The UE 30 receives the group of DL RSs. The UE 30 may record the Rx time instance of each of the group of DL RSs.

In operation 205, the BS 10 may transmit a second signal to the UE 30 through the satellite 20. In the operation 205, the second signal indicates to report a first value from the UE 30. The BS 10 may use the second signal to notify the UE 30 to report the first value. In some embodiments, the BS 10 may use the second signal to notify the UE 30 to report the first value at a given symbol or slot. When the UE 30 receives the second signal, the UE 30 would be ready to report the first value. The first value may be associated with the Rx time instances of the group of DL RSs at the UE 30.

In operation 207, the UE 30 may determine a DL RS subset. The UE 30 may determine the DL RS subset in response to the receipt of the first signal. The UE may determine the DL RS subset in response to the receipt of the second signal. In the operation 207, the UE 30 may determine or calculate the first value based on the DL RS subset. The first value may be determined or calculated based on the differences between Rx time instances of DL RSs of the DL RS subset.

In operation 209, the UE 30 may transmit or report the first value to the BS 10 through the satellite 20. In operation 211, the BS 10 may determine or verify the position of the UE 30 based on the first value. In some embodiments, operation 211 can be omitted.

According to embodiments of the DL TDOA scheme of the present disclosure, a set of DL RSs will be configured or transmitted from a gNB (e.g., the BS 10) to a UE (e.g., the UE 30). The UE will report differences of the Rx time instances of multiple pairs of DL RSs. For example, the UE may report the difference of the Rx time instances of DL RS#0 and DL RS#1, the difference of the Rx time instances of DL RS#0 and DL RS#2, and the difference of the Rx time instances of DL RS#0 and DL RS#3.

The DL RSs of the present disclosure may be positioning reference signals (PRSs) or channel status information reference signals (CSI-RSs). Each DL RS may be associated with a separate identification (ID). For example, each DL RS in a set of DL RSs may include an index. DL RSs may be configured with the same periodicity or offset. Sets of DL RSs may be configured with the same periodicity or offset. DL RSs may be differentiated by different time instances or transmitted at different Tx times. Sets of DL RSs may be differentiated by different time instances or transmitted at different Tx times. DL RSs may be configured with different periodicities or offsets. Sets of DL RSs may be configured with different periodicities or offsets. DL RSs may be differentiated by different indexes. Sets of DL RSs may be differentiated by set indexes. Each RS (e.g., DL RS) may be configured by a specific time instance; for example, each RS may be configured to be transmitted in a given slot index or in a given symbol index. The sets of DL RSs may occur periodically.

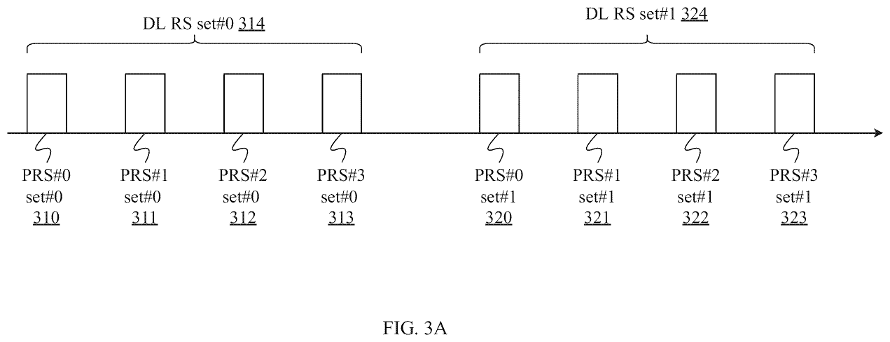

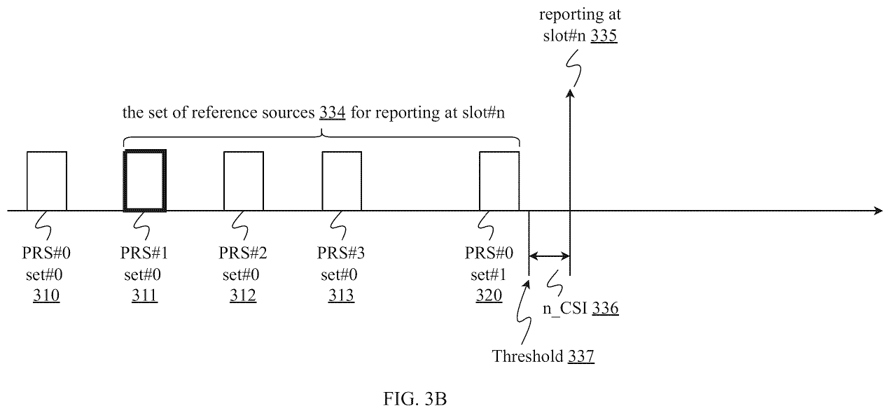

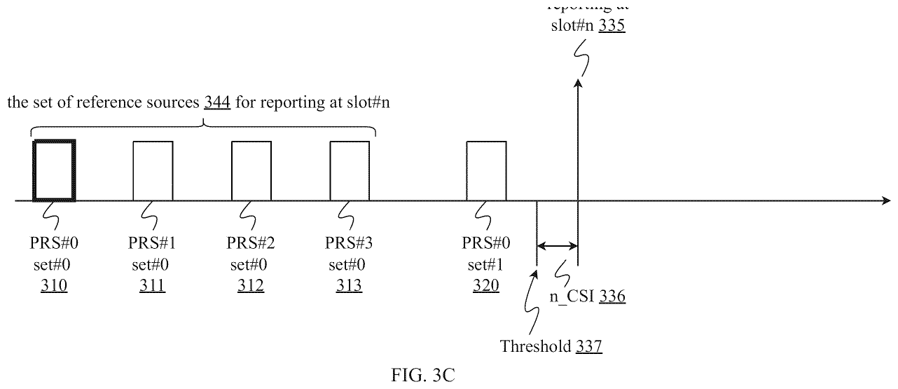

FIG. 3A is a schematic diagram illustrating a group of DL RSs according to some embodiments of the present disclosure. In FIG. 3A, the DL RSs are PRSs. FIG. 3A shows DL RS set#0 (i.e., DL RS set 314) and DL RS set#1 (i.e., DL RS set 324) are transmitted. In some embodiments, more than two sets of DL RSs may be transmitted. The DL RS set 314 includes PRS 310, PRS 311, PRS 312, and PRS 313. PRS 310 has the indexes, including PRS#0 and set#0. The index of PRS 310 shows that this PRS is the first PRS of the first set. PRS 311 has the indexes, including PRS#1 and set#0. PRS 312 has the indexes, including PRS#2 and set#0. PRS 313 has the indexes, including PRS#3 and set#0. The DL RS set 324 includes PRS 320, PRS 321, PRS 322, and PRS 323. The PRSs 320, 321, 322, and 323 may have the indexes similar to those of PRSs 310, 311, 312, and 313.

When there is a reporting configuration, either periodic or aperiodic, a set of reference resources will be determined for the calculation of the values to be reported. For example, when the UE is notified to report some calculations or measurements (e.g., the first value), the UE may determine a set of reference resources (e.g., a DL RS subset) for the calculations or measurements. The calculations or the measurements may be asked to be reported in a periodic way or in an aperiodic way. Four DL RSs may be determined to be a set of reference resources. That is, a set of reference resources may include four DL RSs. In some embodiments, a set of reference resources may include at least one DL RS.

In some embodiments, if the report associated with the DL RSs is aperiodic, a set of DL RSs may be triggered together with the request of the report.

### Embodiment 1-1

In some embodiments, the set of reference resources may be explicitly configured or assigned for each report (e.g., each report of the first value). The set of the reference resources may be explicitly configured or assigned by the BS. For example, the BS may explicitly configure or assign the reference resources by the first signal and/or second signal, which may be transmitted in the operations 201 and 205.

The set of the reference resources may be explicitly configured or assigned for the UE. For example, the BS may explicitly configure or assign the reference resources, and the UE report the first value (e.g., transmitted in the operation 209).

### Embodiment 1-2

FIG. 3B is schematic diagrams illustrating determinations of reference sources according to some embodiments of the present disclosure. In some embodiments, the set of reference resource can be implicitly determined by a time domain offset n_CSI 336. When the UE have an indication 335, which indicates that the report is requested to be transmitted at slot#n, the last DL RS in the set of reference sources 334 should be no later than the threshold 337. The threshold 337 may be defined by the time of slot#n and the time offset n_CSI 336. The n_CSI 336 may be predefined or preconfigured to 4 ms or 5 ms. The n_CSI 336 may be configured or set by signalling between the BS 10 and UE 30.

As shown in FIG. 3B, because the DL RS 320 is the closest DL RS to the threshold 337 and is not later than the threshold 337, the DL RS 320 is assigned as the last DL RS in the set of reference sources 334.

After determination the Rx time instance or the Rx time of the last DL RS in the set of reference sources 334, the other 3 DL RS in the set of reference sources 334 can be the 3 adjacent DL RSs before the last DL RS.

As shown in FIG. 3B, since the DL RS 320 is assigned as the last DL RS in the set of reference sources 334, the closest 3 DL RSs before the DL RS 320 are the DL RSs 311, 312, and 313, and the DL RSs 311, 312, and 313 are assigned as the other 3 DL RSs in the set of reference sources 334. The DL RS 310 may not be assigned as one element of the set of reference sources 334 because the DL RS 310 is the fourth DL RS counted from the DL RS 320.

The first DL RS of the 4 DL RSs in the set of reference sources 334 may be assigned as an anchor resource or a reference resource. The anchor resource may be used to determine the differences of the Rx time instances of the DL RSs in the set of reference sources 334. In the embodiment of FIG. 3B, the DL RS 311 may be the anchor resource, and the differences between the Rx time instances of DL RSs 311 and 312, between the Rx time instances of DL RSs 311 and 313, and between the Rx time instances of DL RSs 311 and 320 would be calculated.

### Embodiment 1-3

FIG. 3C is schematic diagrams illustrating determinations of reference sources according to some embodiments of the present disclosure. The set of reference resources may be implicitly determined by a time domain offset n_CSI 336 and set indexes of the DL RSs. When the UE have an indication 335, which indicates that the report is requested to be transmitted at slot#n, the set of the reference sources should be an entire set of DL RS should be no later than the threshold 337. That is, DL RSs within the same DL RS set prior to the threshold 337 may be determined as the set of reference resources. The threshold 337 may be defined by the time of slot#n and the time offset n_CSI 336. The n_CSI 336 may be predefined or preconfigured to 4 ms or 5 ms. The n_CSI 336 may be configured or set by signalling between the BS 10 and UE 30.

In the embodiment of FIG. 3C, because the DL RSs 310 to 313 are within the same DL RS set (i.e., with set#0) and are prior to the threshold 337, the DL RSs 310 to 313 are selected to be the set of reference resources 344. The DL RS 320 may not be assigned as one element of the set of reference sources 344 because the DL RS 320 is not in the same DL RS set (i.e., with set#0). The first DL RS of the 4 DL RSs in the set of reference sources 344 may be assigned as an anchor resource or a reference resource. The anchor resource may be used to determine the differences of the Rx time instances of the DL RSs in the set of reference sources 344.

In the embodiment of FIG. 3C, the DL RS 310 may be the anchor resource, and the difference between the Rx time instances of DL RSs 310 and 311, the difference between the Rx time instances of DL RSs 310 and 312, and the difference between the Rx time instances of DL RSs 310 and 313 would be calculated.

### Embodiment 1-4

In some embodiments, the set of reference resources may be determined by the UE itself. If the UE determines the set of reference resources by itself, the UE may report the set of reference resources to the BS by reporting resource ID (e.g., PRS numbers shown in FIGS. 3A to 3C) and set ID of the selected DL RSs.

In some embodiments, only the resource ID of the first DL RS in the set of reference resources is reported to the BS. In some embodiments, only the resource ID of the last DL RS in the set of reference resources is reported to the BS. In some embodiments, the resource IDs of all DL RSs in the set of reference resources are reported to the BS.

The UE may determine the set of reference resources based on a time domain offset between the time instance to report and the time instance of the first or the last DL RS in the set of reference resources. The time domain offset may several milliseconds or serval slots/symbols.

### Embodiment 1-5

In the DL TDOA schemes, the UE may report the first value to the BS (e.g., the operation 209). The report content transmitted by the UE may be associated with the differences in the time domain. The report content transmitted by the UE may be associated with the differences between Rx time instances of the DL RSs at the UE side. In the embodiments of FIG. 3C, the report content from the UE may include the difference between the Rx time instances of DL RSs 310 and 311, the difference between the Rx time instances of DL RSs 310 and 312, and the difference between the Rx time instances of DL RSs 310 and 313.

### Embodiment 1-6

The report of the UE may be based on UTC time instance (i.e., coordinated universal time) at the UE side. To save signalling overhead, the reported differences of the Rx time instances can exclude the configured or known time difference between two DL RSs.

For example, if the difference of the Tx time instances of two DL RSs is configured or known as 4 ms, the difference of the Rx time instances of the two DL RSs is calculated or measured as 5 ms, and the reported difference of the Rx time instances of the two DL RSs may be 1 ms (i.e., 4 ms is subtracted from 5 ms).

In some embodiments, PRS#0, PRS#1, PRS#2, and PRS#3 (e.g., DL RSs) may be configured to be transmitted at slot#0, slot#3, slot#6, slot#9, respectively. If the difference of the measured Rx time instances of PRS#0 and PRS#1 is 4 ms, the time length of 3 slots (e.g., 15 KHz sub-carrier space, 3 ms) may be excluded, and the reported difference is 1 ms. If the difference of the measured Rx time instances of PRS#0 and PRS#2 is 7.5 ms, the time length of 6 slots (e.g., 6 ms) may be excluded, and the reported difference is 1.5 ms.

One of the advantages of excluding the configured or known time difference is that the change of the synchronization signal block (SSB) Tx time instance at BS side can be accounted.

### Embodiment 1-7

The report content may be based on the slot/symbol index at UE side with respect to a reference sub-carrier space (SCS). The reference SCS may be explicitly configured or implicitly determined based on the frequency bands, the active DL bandwidth parts (BWPs), or UL BWP, etc. The reported difference of the Rx time instances can also exclude the configured or known time difference between two DL RSs. Impact on the differences of the SSB Tx time instances at the BS side may be solved by the BS itself.

Upon receipt of the report from the UE, the BS may determine or verify the position of the UE. According to the criteria for determining a set of reference resources definition, the BS can know the accurate Tx time instances of PRS#0, PRS#1, PRS#2, and PRS#3. With satellite orbit information, the BS can calculate the Rx time instance of each of PRS#0, PRS#1, PRS#2, and PRS#3 at the satellite side. Based on the SSB change known at the BS side and the reported time difference between PRS#0 and PRS#1, the reported time difference between PRS#0 and PRS#2, and the reported time difference between PRS#0 and PRS#3, the BS can know the actual time difference between PRS#0 and PRS#1, the actual time difference between PRS#0 and PRS#2, and the actual time difference between PRS#0 and PRS#3 due to the transmissions between the satellite and the UE. Based on the actual time differences, the BS can determine the position of the UE and then verify whether the UE reported position is accurate or not.

### Embodiment 2: UL TDOA

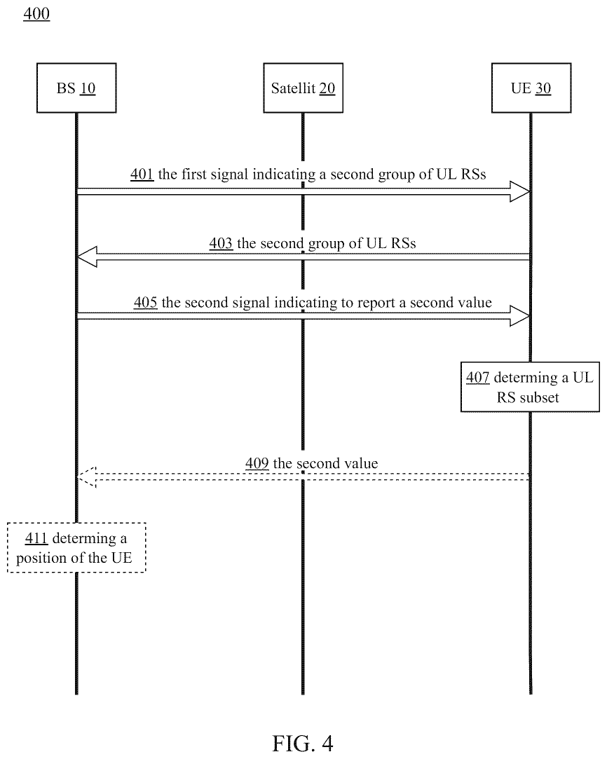

FIG. 4 is a schematic diagram 400 illustrating transmissions of a UL TDOA scheme according to some embodiments of the present disclosure. In the schematic diagram of a UL TDOA scheme, the BS 10, the satellite 20, and the UE 30 may be involved. The UL TDOA scheme provided in the present disclosure may be for the scenario with a single satellite. In some embodiments, the UL TDOA scheme provided in the present disclosure may be for the scenario with multiple satellites.

The schematic diagram 400 includes a plurality of operations. In operation 401, the BS 10 may transmit a first signal to the UE 30 through the satellite 20. In the operation 401, the first signal indicates a group of UL RSs at multiple time instances. The BS 10 may use the first signal to notify the UE 30 to transmit the group of UL RSs. In some embodiments, the BS 10 may use the first signal to notify the UE 30 that the BS 10 may determine or verify the position of the UE 30 based on UL RSs. When the UE 30 receives the first signal, the UE 30 would be ready to transmit a group of UL RSs.

In operation 403, the UE 30 may transmit a group of UL RSs to the BS 10 through the satellite 20. The BS 10 receives the group of UL RSs. The UE 30 may record the Tx time instance of each of the group of UL RSs.

In operation 405, the BS 10 may transmit a second signal to the UE 30 through the satellite 20. In the operation 405, the second signal indicates reporting of a second value from the UE 30. The BS 10 may use the second signal to notify the UE 30 to report the second value. In some embodiments, the BS 10 may use the second signal to notify the UE 30 to report the second value at a given symbol or slot. When the UE 30 receives the second signal, the UE 30 would be ready to report the second value. The second value may be associated with the with Tx time instances of the group of UL RSs at the UE 30.

In operation 407, the UE 30 may determine a UL RS subset. The UE 30 may determine the UL RS subset in response to the receipt of the first signal. The UE may determine the UL RS subset in response to the receipt of the second signal. In the operation 407, the UE 30 may determine or calculate the second value based on the UL RS subset. The second value may be determined or calculated based on the differences between Tx time instances of UL RSs of the UL RS subset.

In operation 409, the UE 30 may transmit or report the second value to the BS 10 through the satellite 20. In operation 411, the BS 10 may determine or verify the position of the UE 30 based on the second value. In some embodiments, operation 409 can be omitted, and in some other embodiments, operation 411 can be omitted. In some embodiments, the BS 10 may determine the uplink transmission time instances for the second group of UL RSs.

In UL TDOA schemes, the UE may transmit multiple UL RSs at different time instances (e.g., with different Tx times). In some embodiments, the UE may transmit 4 SRSs. Then, the BS may measure the Rx time instances of the UL RSs and calculate the differences of the receptions time instances. The calculated differences of the Rx time instances at the BS side can be used to determine the differences of the propagation delay between the UE and the satellite for multiple pairs of UL RSs. For example, the BS may determine the difference of the propagation delay between the UE and the satellite for the pair of the first and second UL RSs, the pair of the first and third UL RSs, and the pair of the first and fourth UL RSs. The BS then calculate the position of the UE based on the differences of the propagation delay between the UE and the satellite.

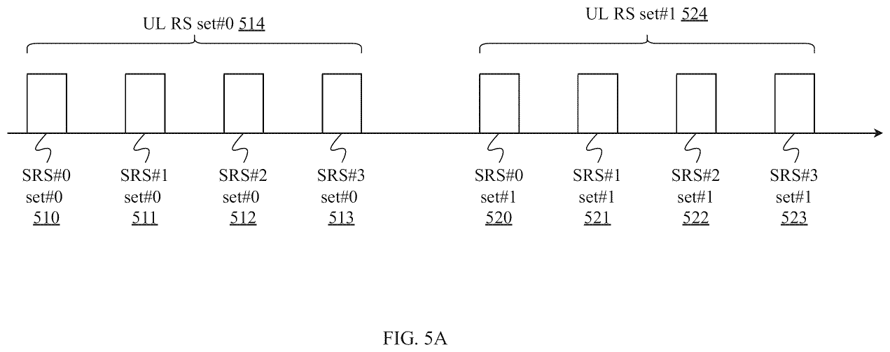

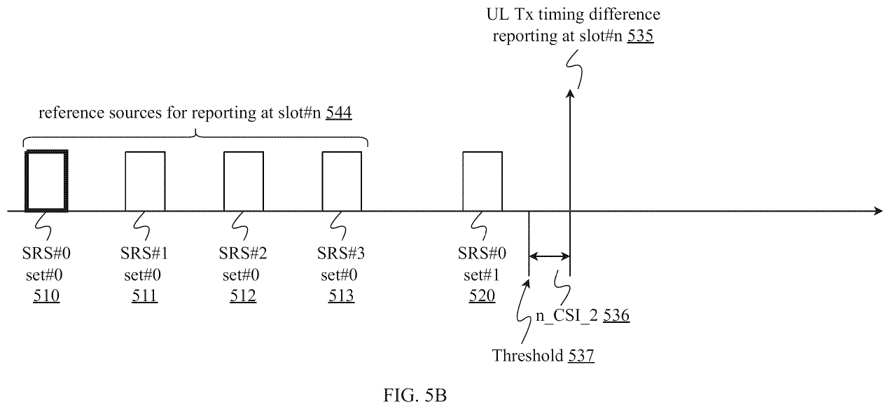

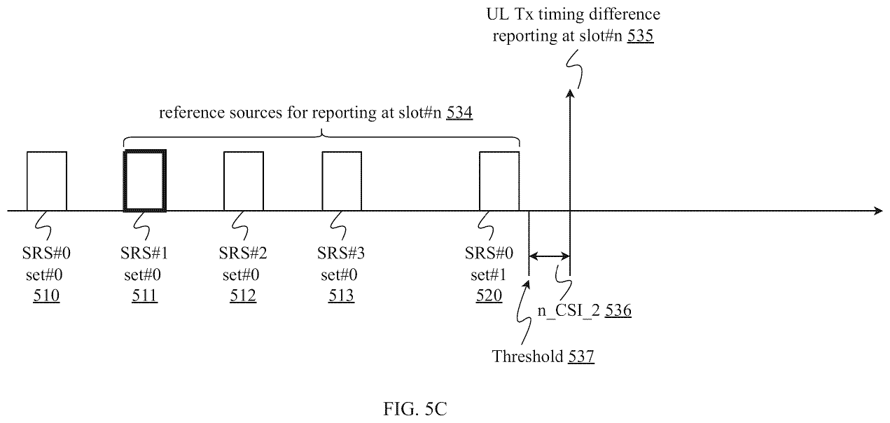

FIG. 5A is a schematic diagram illustrating a group of UL RSs according to some embodiments of the present disclosure. In UL TDOA schemes, a set of UL RS (e.g., including four UL RSs) may be configured from the BS to the UE in a periodic way or in an aperiodic way. In FIG. 5A, the UL RSs are SRSs. FIG. 5A shows UL RS set#0 (i.e., UL RS set 514) and UL RS set#1 (i.e., UL RS set 524) are transmitted. In some embodiments, one set of UL RSs may be transmitted. In some embodiments, more than two sets of UL RSs may be transmitted. The UL RS set 514 includes SRS 510, SRS 511, SRS 512, and SRS 513. SRS 510 has the indexes, including SRS#0 and set#0. The index of SRS 510 shows that this SRS is the first SRS of the first set. SRS 511 has the indexes, including SRS#1 and set#0. SRS 512 has the indexes, including SRS#2 and set#0. SRS 513 has the indexes, including SRS#3 and set#0. The UL RS set 524 includes SRS 520, SRS 521, SRS 522, and SRS 523. The SRSs 520, 521, 522, and 523 may have the indexes similar to those of SRSs 510, 511, 512, and 513.

Timing advance (TA) may change for multiple UL RS transmissions. The determination of the TA in a NTN may be based on a common TA or a UE-specific TA. The UE-specific TA may be calculated based on the positions of the satellite and the UE. Thus, the differences of the TAs for different UL RSs may be reported to the BS, and the BS may determine the propagation delay between the satellite and the UE based on the different UL RSs and the corresponding TAs. The second value reported by the UE may be associated with the TAs.

In the UL TDOA schemes, one or more values may be reported. The one or more values may be associated with differences of TAs for a set of UL RSs. The one or more values may be associated with differences of UL Tx time instances for a set of UL RSs. The report from the UE may be periodic or aperiodic.

### Embodiment 2-1

When the report from the UE is periodic, the differences of the UL Tx time instances of different pairs of UL RSs may be determined. For example, the UE may determine the difference of the Tx time instances of the pair of UL RS#0 and UL RS#1, the difference of the Tx time instances of the pair of UL RS#0 and UL RS#2, and the difference of the Tx time instances of the pair of UL RS#0 and UL RS#3. The differences of the Tx time instances may be determined based on the UTC time instances. The differences of the Tx time instances may be determined based on the slot/symbol indexes. The slot indexes or the symbol indexes may be determined based on the SSB reception (which may be applied in a DL synchronization procedure).

An entire set of UL RSs may be assigned as the set of reference resources, which is used to determine the differences of Tx time instances or the differences of the TAs. The entire set of UL RSs may include serval UL RSs (typically 4 UL RSs), and the UL RSs may be numbered as UL RS#0, UL RS#1, UL RS#2, UL RS#3 according to the sequence in the time domain. Since the entire set of UL RSs is assigned as the set of reference resources, and the set of reference resources is consisted of UL RS#0, UL RS#1, UL RS#2, and UL RS#3.

### Embodiment 2-2

The report from the UE may be periodic. FIG. 5B is schematic diagrams illustrating determinations of reference sources according to some embodiments of the present disclosure. The set of reference resources may be implicitly determined by a time domain offset n_CSI_2 536 and set indexes of the UL RSs. When the UE have an indication 535, which indicates that the report is requested to be transmitted at slot#n, the set of the reference sources should be an entire set of UL RS and should be no later than the threshold 537. That is, UL RSs within the same UL RS set prior to the threshold 537 may be determined as the set of reference resources. In other words, the latest set of UL RS, in which the latest UL RS is prior to the threshold 537, may be assigned as the set of reference resources. The threshold 537 may be defined by the time of slot#n and the time offset n_CSI_2 536. The n_CSI_2 536 may be predefined or preconfigured to 4 ms or 5 ms. The n_CSI_2 536 may be configured or set by signalling between the BS 10 and UE 30.

In the embodiment of FIG. 5B, because the UL RSs 510 to 513 are within the same UL RS set (i.e., with set#0) and are prior to the threshold 337, the UL RSs 510 to 513 are selected to be the set of reference resources 544. The UL RS 520 may not be assigned as one element of the set of reference sources 544 because the UL RS 520 is not in the same UL RS set (i.e., with set#0). The first UL RS of the 4 UL RSs in the set of reference sources 544 may be assigned as an anchor resource or a reference resource. The anchor resource may be used to determine the differences of the Rx time instances of the UL RSs in the set of reference sources 544.

In the embodiment of FIG. 5B, the UL RS 510 may be the anchor resource, and the difference between the Tx time instances (or TAs) of UL RSs 510 and 511, the difference between the Tx time instances (or TAs) of UL RSs 510 and 512, and the difference between the Tx time instances (or TAs) of UL RSs 510 and 513 would be calculated.

### Embodiment 2-3

The report from the UE may be aperiodic. FIG. 5C is schematic diagrams illustrating determinations of reference sources according to some embodiments of the present disclosure. In some embodiments, the set of reference source may be implicitly determined by a time domain offset n_CSI_2 536. When the UE have an indication 535, which indicates that the report is requested to be transmitted at slot#n, the last UL RS in the set of reference sources 534 should be no later than the threshold 537. The threshold 537 may be defined by the time of slot#n and the time offset n_CSI_2 536. The n_CSI_2 536 may be predefined or preconfigured to 4 ms or 5 ms. The n_CSI_2 536 may be configured or set by signalling between the BS 10 and UE 30.

As shown in FIG. 5C, because the UL RS 520 is the closest UL RS to the threshold 537 and is not later than the threshold 537, the UL RS 520 is assigned as the last UL RS in the set of reference sources 534.

After determination the Tx time instance or the Tx time of the last UL RS in the set of reference sources 534, the other 3 UL RS in the set of reference sources 334 can be the 3 adjacent UL RSs before the last UL RS.

As shown in FIG. 5C, since the UL RS 520 is assigned as the last UL RS in the set of reference sources 534, the closest 3 UL RSs before the UL RS 320 are the UL RSs 511, 512, and 513, and the UL RSs 511, 512, and 513 are assigned as the other 3 UL RSs in the set of reference sources 534. The UL RS 510 may not be assigned as one element of the set of reference sources 534 because the UL RS 510 is the fourth UL RS counted from the UL RS 520.

The first UL RS in the set of reference sources 534 may be assigned as an anchor resource or a reference resource. The anchor resource may be used to determine the differences of the Tx time instances (or TAs) of the UL RSs in the set of reference sources 534. In the embodiment of FIG. 5C, the UL RS 511 may be the anchor resource, and the difference between the Tx time instances (or TAs) of UL RSs 511 and 512, the difference between the Tx time instances (or TAs) UL RSs 511 and 513, and the difference between the Tx time instances (or TAs) UL RSs 511 and 520 would be calculated.

The report content from the UE in the embodiments 2, 2-1, 2-2, and 2-3 may be similar to the report content disclosed in the embodiment 1-5, 1-6, and 1-7.

### Embodiment 3: multi-RTT

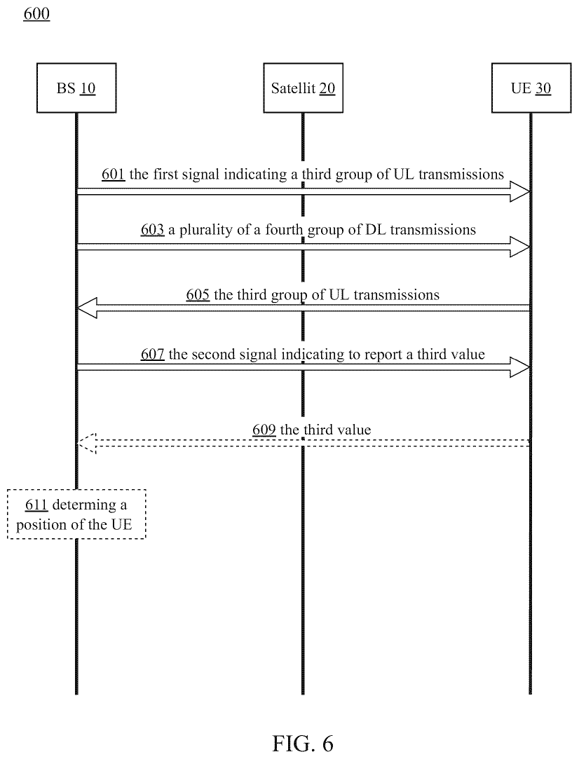

FIG. 6 is a schematic diagram 600 illustrating transmissions of a multi-RTT scheme according to some embodiments of the present disclosure. In the schematic diagram of a multi-RTT scheme, the BS 10, the satellite 20, and the UE 30 may be involved. The multi-RTT scheme provided in the present disclosure may be for the scenario with a single satellite. In some embodiments, the multi-RTT scheme provided in the present disclosure may be for the scenario with multiple satellites.

The schematic diagram 600 includes a plurality of operations. In operation 601, the BS 10 may transmit a first signal to the UE 30 through the satellite 20. In the operation 401, the first signal indicates a group of transmissions. In the operation 401, the first signal indicates a group of DL transmissions. In the operation 401, the first signal indicates a group of UL transmissions. The BS 10 may use the first signal to notify the UE 30 that a group of DL transmissions would be transmitted. The BS 10 may use the first signal to notify the UE 30 to transmit a group of UL transmissions upon reception of the group of DL transmissions. In some embodiments, the BS 10 may use the first signal to notify the UE 30 that the BS 10 will determine or verify the position of the UE 30 based on transmissions. When the UE 30 receives the first signal, the UE 30 would be ready to receive a group of DL transmissions and/or transmit a group of UL transmissions.

In operation 603, the BS 10 may transmit a group of DL transmissions to the UE 30 through the satellite 20. The group of DL transmissions may be transmitted through one or more satellite 20. The UE 30 receives the group of DL transmissions. The BS 10 may record the Tx time instance of each of the group of DL transmissions. The UE 30 may record the Rx time instance of each of the group of DL transmissions.

In operation 605, in response to the receptions of the group of DL transmissions, the UE 30 may transmit a group of UL transmissions to the BS 10 through the satellite 20. The group of UL transmissions may be transmitted through one or more satellite 20. The BS 10 receives the group of UL transmissions. The UE 30 may record the Tx time instance of each of the group of UL transmissions. The BS 10 may record the Rx time instance of each of the group of UL transmissions.

In operation 607, the BS 10 may transmit a second signal to the UE 30 through the satellite 20. In the operation 405, the second signal indicates to report a third value from the UE 30. The BS 10 may use the second signal to notify the UE 30 to report the third value. In some embodiments, the BS 10 may use the second signal to notify the UE 30 to report the third value at a given symbol or slot. When the UE 30 receives the second signal, the UE 30 would be ready to report the third value. The third value may be associated with the Tx time instances of the group of UL transmissions at the UE 30.

In operation 609, the UE 30 may transmit or report the third value to the BS 10 through the satellite 20. In operation 611, the BS 10 may determine or verify the position of the UE 30 based on the third value. In some embodiments, operation 609 can be omitted, and in some other embodiments, operation 611 can be omitted. In some embodiments, the BS 10 may determine the uplink transmission time instances for the s third group of UL transmissions.

In multi-RTT schemes, the UE may be configured to transmit a UL transmission upon reception of a DL transmission. Based on the Tx time instance of DL transmission and reception (Rx) time instance of UL transmission at the BS side, corresponding Tx time instance and Rx time instance for the DL and UL transmissions at the satellite may be determined. If the BS knows the difference between the Rx time instance of the DL transmission and the Tx time instance of the UL transmission at the UE side, the BS may determine the RTT (round trip time) between the satellite and the UE. With at least 3 satellites, the position of the UE may be determined at the BS side.

The UE may report the difference between the Rx time instance of the DL transmission and the Tx time instance of the UL transmission at the UE side. The present disclosure further include some features according to the characteristics of a NTN network, such as large propagation delay and a single satellite. The present disclosure provide several embodiments for reporting or restricting the difference between the DL Rx time instance and the Tx time instance.

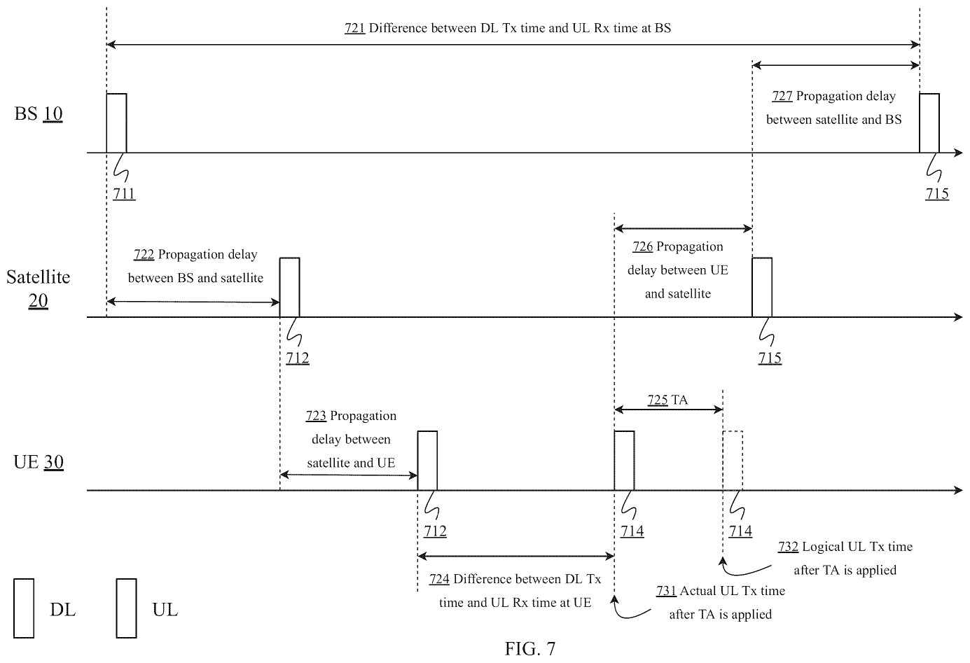

FIG. 7 is a schematic diagram illustrating a multi-RTT scheme according to some embodiments of the present disclosure. The BS 10 transmits a DL transmission 711. Upon reception of the DL transmission 711, the satellite 20 transmits a DL transmission 712. There is a propagation delay 722 between the transmissions of DL transmissions 711 and 712.

The satellite 20 transmits the DL transmission 712, and the UE 30 receives the DL transmission 712. There is a propagation delay 723 between the transmission of DL transmission 712 at the satellite 20 and the reception of the DL transmission 712 at the UE 30.

Upon reception of the DL transmission 712, the UE 30 transmits the UL transmission 714 at the actual UL Tx time instance 731 after the TA 725 is applied. There is a time difference 724 between the Rx time instance of the DL transmission 712 and the actual UL Tx time instance 731. After the TA 725 is applied, the UL transmission 714 may be deemed as transmitting at the logical UL Tx time instance 732 from the view of the satellite 20 and the BS 10. The TA 725 may be the difference between the actual UL Tx time instance 731 and the logical UL Tx time instance 732.

The UE 30 transmits the UL transmission 714. Upon reception of the UL transmission 714, the satellite 20 transmits a UL transmission 715. There is a propagation delay 726 between the transmissions of UL transmissions 714 and 715.

The satellite 20 transmits the UL transmission 715, and the BS 10 receives the UL transmission 715. There is a propagation delay 723 between the transmission of UL transmission 715 at the satellite 20 and the reception of the UL transmission 715 at the BS 10.

Upon reception of the UL transmission 715, the BS may determine the time difference between the Tx time instance of the DL transmission 711 and the Rx time instance of the UL transmission 715. Based on the Tx time instance of DL transmission 711 and reception (Rx) time instance of UL transmission 715 at the BS 10, corresponding Tx time instance and Rx time instance for the DL and UL transmissions at the satellite 20 may be determined. When the BS knows the time difference 724 and the TA 725, the BS may determine the RTT (round trip time) between the satellite 20 and the UE 10. The time difference 724 and the TA 725 may be predetermined in the system or reported by the UE 30.

### Embodiment 3-1

The logic offset between the reception of the DL transmission and the transmission of the UL transmission may be configured, predetermined, or predefined. The TA for each UL transmission may be reported.

In some embodiments, the TA for every transmission of UL transmissions may be predetermined as an absolute value.

In some embodiments, the TA may be a differential value with respect to the TA of a reference transmission time instance or a reference transmission time. The TA may be a differential value with respect to a reference TA value.

The TA may be reported in a UL transmission or reported together with a UL transmission. The TA may be reported after the transmission of the last UL transmission.

The TA may be reported based on a trigger from the BS. The BS may transmit an additional signal to trigger the report of the TA from the UE. For example, the reported TA may be for the nearest 4 pairs of DL Rx and UL Tx which are before the reporting time instance of the TA in the time domain.

### Embodiment 3-2

In some embodiments, it is restricted that the TA is a predetermined, predefined, or configured value.

In some embodiments, the value of the TA may be predetermined based on a K-offset parameter. The K-offset parameter may be a cell-specific K-offset parameter or a currently applicable K-offset parameter. In some embodiments, based on the K-offset parameter, when the DL transmission is received at the n-th slot/symbol, and the UL transmission may be transmitted at the (n+k+K-offset)-th slot/symbol.

In some embodiments, the value of the TA may be predetermined as 0

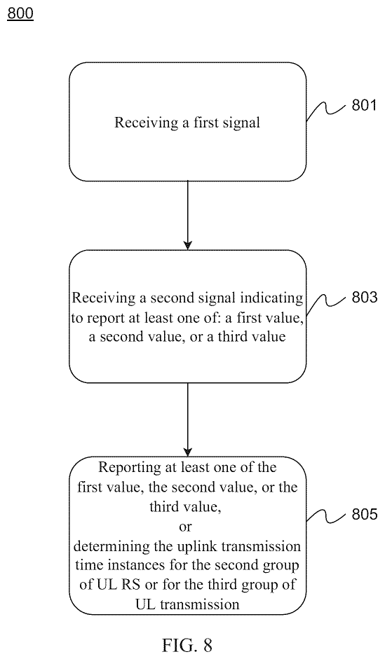

FIG. 8 is a flowchart of a method 800 according to some embodiments of the present disclosure. The method 800 may be performed by a UE. In some embodiments, the UE performing the method 800 may be the UE 30.

In operation 801, the UE may receive a first signal. The first signal may indicate at least one of: a first group of downlink (DL) reference signals (RSs) at multiple time instances, a second group of uplink (UL) RSs at multiple time instances, or a third group of UL transmissions at multiple time instances upon receptions of a fourth group of DL transmissions at multiple time instances.

In operation 803, the UE may receive a second signal. The second signal may indicate to report at least one of: a first value associated with reception time instances of the first group of DL RSs, a second value associated with transmission time instances of the second group of UL RSs, or a third value associated with transmission time instances of the third group of UL transmissions.

In operation 805, the UE may report at least one of the first value, the second value, or the third value. In some embodiments of operation 805, the UE may determine the uplink transmission time instances for the second group of UL RSs or for the third group of UL transmissions.

In some embodiments, the method 800 may further comprises: determining a DL RS subset based on the first signal; and calculating the first value based on the DL RS subset. The DL RS subset is selected from the first group of DL RSs, and the first value is calculated based on the differences between reception time instances of DL RSs of the DL RS subset.

In some embodiments of the method 800, the DL RS subset may be configured (e.g., by a BS).

In some embodiments of the method 800, the DL RS subset may be based on the reception times of the plurality of DL RSs.

In some embodiments, the method 800 further comprises: dividing the first group of DL RSs into multiple subgroups based on transmission time instances of the plurality of DL RSs.

In some embodiments, the method 800 further comprises: assigning a first DL RS of one of the subgroups as a reference DL RS of the DL RS subset.

In some embodiments, the method 800 further comprises: determining a last DL RS of the DL RS subset based on reporting time instance of the first value and a first predetermined or configured threshold.

In some embodiments, the method 800 further comprises: reporting an index of at least one DL RS of the DL RS subset.

In some embodiments of the method 800, the first value may be calculated based on UTC time instances of the first group of DL RSs or based on slot/symbol indexes of the first group of DL RSs.

In some embodiments of the method 800, the first value may be calculated by excluding a preconfigured transmission time difference of DL RSs in the DL RS subset.

In some embodiments, the method 800 further comprises: determining a UL RS subset based on the first signal; and calculating the second value based on the UL RS subset. The UL RS subset is selected from the second group of UL RSs, and the second value is calculated based on the differences between the transmission time instances of UL RSs of the UL RS subset.

In some embodiments of the method 800, the second value may be calculated based on UTC transmission time instances of the UL RSs of the UL RS subset or based on slot/symbol indexes of the UL RSs of the UL RS subset.

In some embodiments of the method 800, the second value is determined by excluding a preconfigured transmission time difference of UL RSs in the UL RS subset.

In some embodiments of the method 800, each UL RSs of the UL RS subset may be configured or determined based on reporting time instance for the second value.

In some embodiments, the method 800 further comprises: dividing the second group of UL RSs into multiple subgroups based on the transmission time instances of the second group of UL RSs.

In some embodiments, the method 800 further comprises: determining a first UL RS of one of the subgroups as a reference UL RS the UL RS subset.

In some embodiments, the method 800 further comprises: determining the third value based on at least one timing advance (TA) for the third group of UL transmissions.

In some embodiments of the method 800, the at least one TA is based on a predetermined time domain offset between the receptions of the fourth group of DL transmissions and transmissions of the third group of UL transmissions.

In some embodiments of the method 800, the at least one TA may be 0.

In some embodiments, the method 800 further comprises: reporting one TA for each of the third group of UL transmissions.

In some embodiments of the method 800, the at least one TA may be a differential TA value with respect to a reference TA, or an absolute value.

In some embodiments of the method 800, one TA may be reported in the corresponding one UL transmission.

In some embodiments of the method 800, the at least one TA may be reported after the last UL transmission of the third group of UL transmissions.

In some embodiments of the method 800, the at least one TA may be reported based on a third indication from another apparatus.

In some embodiments of the method 800, the at least one TA for a number of pairs of DL transmission and UL transmission is reported, and the time instances of DL transmission and UL transmissions are the latest ones prior to the receipt of the third indication.

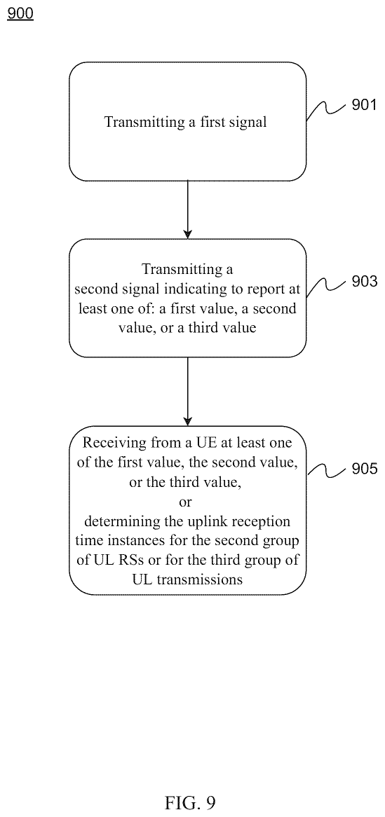

FIG. 9 is a flowchart of a method 900 according to some embodiments of the present disclosure. The method 900 may be performed by a base station (BS). In some embodiments, the BS performing the method 900 may be the BS 10.

In operation 901 of the exemplary method 900 shown in FIG. 9, the BS may transmit a first signal. The first signal may indicate at least one of: a first group of downlink (DL) reference signals (RSs) at multiple time instances, a second group of uplink (UL) RSs at multiple time instances, or a third group of UL transmissions at multiple time instances upon receptions of a fourth group of DL transmissions at multiple time instances.

In operation 903, the BS may transmitting a second signal. The second signal may indicate to report at least one of: a first value associated with reception time instances of the first group of DL RSs, a second value associated with transmission time instances of the second group of UL RSs, or a third value associated with transmission time instances the third group of UL transmissions.

In operation 905, the BS may receive from an apparatus at least one of the first value, the second value, or the third value, or the third value. In some embodiments of operation 905, the BS may determine the uplink reception time instances for the second group of UL RSs or for the third group of UL transmissions.

In some embodiments, the method 900 may further comprises transmitting the first group of DL RSs, and wherein the first value is calculated based on a DL RS subset within the first group of DL RSs.

In some embodiments of the method 900, wherein the DL RS subset is configured (e.g., by the BS).

In some embodiments, the method 900 may further comprises receiving an index of at least one DL RS of the DL RS subset.

In some embodiments of the method 900, the first value may be based on UTC reception time instances of the first group of DL RSs or based on slot/symbol indexes of the first group of DL RSs.

In some embodiments of the method 900, the first value is calculated by excluding a preconfigured transmission time difference of DL RSs in the DL RS subset.

In some embodiments, the method 900 may further comprises receiving a UL RS subset, wherein the second value is calculated based on the differences between the transmission time instances of UL RSs of the UL RS subset, and wherein the UL RS subset is within the second group of UL RSs.

In some embodiments of the method 900, the second value may be based on UTC transmission time instances of the UL RSs of the UL RS subset or based on slot/symbol indexes of the UL RSs of the UL RS subset.

In some embodiments of the method 900, the second value is determined by excluding a preconfigured transmission time difference of the UL RSs in the UL RS subset.

In some embodiments of the method 900, the third value may be configured or determined based on at least one timing advance (TA) for the third group of UL transmissions.

In some embodiments of the method 900, the at least one TA may be based on a predetermined time domain offset between the receptions of the fourth group of DL transmissions and transmissions of the third group of UL transmissions.

In some embodiments of the method 900, the at least one TA may be 0.

In some embodiments, the method 900 may further comprises receiving one TA for each UL transmission of the third group of UL transmissions.

In some embodiments of the method 900, the at least one TA may be a differential TA value with respect to a reference TA, or an absolute value.

In some embodiments of the method 900, one TA may be received in the corresponding one UL transmission.

In some embodiments of the method 900, the at least one TA may be received after the last UL transmission of the third group of UL transmissions is received.

In some embodiments, the method 900 may further comprises transmitting a third indication indicating a report of the at least one TA.

In some embodiments of the method 900, the at least one TA for a number of pairs of DL transmission and UL transmission is received, the time instances of DL transmission and UL transmission are the latest ones prior to the transmission of the third indication.

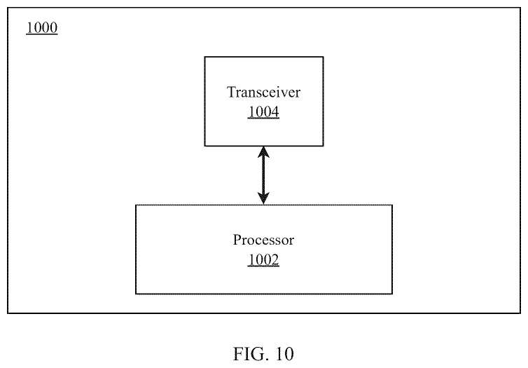

FIG. 10 is a simplified block diagram of an apparatus 1000 according to some embodiments of the present disclosure. The apparatus 1000 may be the UE 30.

Referring to FIG. 10, the apparatus 1000 may include at least one processor 1002, and at least one transceiver 1004. In some embodiments of the present disclosure, at least one transceiver 1004 may implemented as at least one receiver and at least one transmitter. The at least one processor 1002 may be coupled to the transceiver 1004. The at least one processor 1002 may be configured to implement a method with the at least one transceiver 1004. The method implemented by the apparatus 1000 may comprises: receiving a first signal; receiving a second signal indicating to report at least one of: a first value associated with reception time instances of the first group of DL RSs, a second value associated with transmission time instances of the second group of UL RSs, or a third value associated with transmission time instances of the third group of UL transmissions; and report at least one of the first value, the second value, or the third value or determine the UL transmission time instances for the second group of UL RSs or for the third group of UL transmissions. The method implemented by the apparatus 1000 may be a method according to any embodiment of the present disclosure, for example, one of the methods shown in FIGS. 2 to 9.

Referring to FIG. 10 again, the apparatus 1000 may be the BS 10. The at least one processor 1002 may be configured to implement a method with the at least one transceiver 1004. The method implemented by the apparatus 1000 may comprises: transmitting a first signal; transmitting a second signal indicating to report at least one of: a first value associated with reception time instances of the first group of DL RSs, a second value associated with transmission time instances of the second group of UL RSs, or a third value associated with transmission time instances of the third group of UL transmissions; and receiving at least one of the first value, the second value, or the third value, or determining the uplink reception time instances for the second group of UL RSs or for the third group of UL transmissions. The method implemented by the apparatus 1000 may be a method according to any embodiment of the present disclosure, for example, one of the methods shown in FIGS. 2-9

Some embodiments of the present disclosure may be disclosed below:

Embodiment 1: An apparatus, comprising:
a wireless transceiver; and
a processor coupled to the wireless transceiver and configured to:
   receive a first signal indicating at least one of: a first group of downlink (DL) reference signals (RSs) at multiple time instances, a second group of uplink (UL) RSs at multiple time instances, or a third group of UL transmission at multiple time instances upon receptions of a fourth group of DL transmissions at multiple time instances;
   receive a second signal indicating to report at least one of: a first value associated with reception time instances of the first group of DL RSs, a second value associated with transmission time instances of the second group of UL RSs, or a third value associated with transmission time instances of the third group of UL transmission; and
   report at least one of the first value, the second value, or the third value or determine the UL transmission time instances for the second group of UL RSs or for the third group of UL transmissions.

Embodiment 2: The apparatus of Embodiment 1, wherein the processor is further configured to:
determine a DL RS subset based on the first signal; and
calculate the first value based on the DL RS subset,
wherein the DL RS subset is selected from the first group of DL RSs, and the first value is calculated based on the differences between reception time instances of DL RSs of the DL RS subset.

Embodiment 3: The apparatus of Embodiment 2, wherein the DL RS subset is configured.

Embodiment 4: The apparatus of Embodiment 2, wherein the DL RS subset is based on the reception times of the first group of DL RSs.

Embodiment 5: The apparatus of Embodiment 4, wherein the processor is further configured to divide the first group of DL RSs into multiple subgroups based on transmission time instances of the first group of DL RSs.

Embodiment 6: The apparatus of Embodiment 5, wherein the processor is further configured to assign a first DL RS of one of the subgroups as a reference DL RS of the DL RS subset.

Embodiment 7: The apparatus of Embodiment 4, wherein the processor is further configured to determine a last DL RS of the DL RS subset based on reporting time instance of the first value and a first predetermined or configured threshold.

Embodiment 8: The apparatus of Embodiment 4, wherein the processor is further configured to report an index of at least one DL RS of the DL RS subset.

Embodiment 9: The apparatus of Embodiment 1, wherein the first value is calculated based on UTC reception time instances of the first group of DL RSs or based on slot/symbol indexes of the first group of DL RSs.

Embodiment 10: The apparatus of Embodiment 2, wherein the first value is calculated by excluding a preconfigured transmission time difference of DL RSs in the DL RS subset.

Embodiment 11: The apparatus of Embodiment 1, wherein the processor is further configured to:
determine a UL RS subset based on the first signal; and
calculate the second value based on the UL RS subset,
wherein the UL RS subset is selected from the second group of UL RSs, and the second value is calculated based on the differences between the transmission time instances of UL RSs of the UL RS subset.

Embodiment 12: The apparatus of Embodiment 11, wherein the second value is calculated based on UTC transmission time instances of the UL RSs of the UL RS subset or based on slot/symbol indexes of the UL RSs of the UL RS subset.

Embodiment 13: The apparatus of Embodiment 11, wherein the second value is determined by excluding a preconfigured transmission time difference of the UL RSs in the UL RS subset.

Embodiment 14: The apparatus of Embodiment 11, wherein each UL RSs of the UL RS subset is configured or determined based on reporting time instance for the second value.

Embodiment 15: The apparatus of Embodiment 11, wherein the processor is further configured to divide the second group of UL RSs into multiple subgroups based on the transmission time instances of the second group of UL RSs.

Embodiment 16: The apparatus of Embodiment 15, wherein the processor is further configured to determine a first UL RS of one of the subgroups as a reference UL RS of the UL RS subset.

Embodiment 17: The apparatus of Embodiment 1, wherein the processor is further configured to determine the third value based on at least one timing advance (TA) for the third group of UL transmissions.

Embodiment 18: The apparatus of Embodiment 17, wherein the at least one TA is based on a predetermined time domain offset between the receptions of the fourth group of DL transmissions of the third group of UL transmissions.

Embodiment 19: The apparatus of Embodiment 17, wherein the at least one TA is 0.

Embodiment 20: The apparatus of Embodiment 17, wherein the processor is further configured to report one TA for each of the third group of UL transmissions.

Embodiment 21: The apparatus of Embodiment 20, wherein the at least one TA is a differential TA value with respect to a reference TA, or an absolute value.

Embodiment 22: The apparatus of Embodiment 17, wherein one TA is reported in the corresponding one UL transmissions.

Embodiment 23: The apparatus of Embodiment 17, wherein the at least one TA is reported after the last UL transmission of the third group of UL transmissions.

Embodiment 24: The apparatus of Embodiment 17, wherein the at least one TA is reported based on a third indication from another apparatus.

Embodiment 25: The apparatus of Embodiment 24, wherein the at least one TA for a number of pairs of DL transmission and UL transmission is reported, and the time instances of DL transmission and UL transmission are the latest ones prior to the receipt of the third indication.

Embodiment 26: an Apparatus, comprising:
a wireless transceiver; and
a processor coupled to the wireless transceiver and configured to:
   transmit a first signal indicating at least one of: a first group of downlink (DL) reference signals (RSs) at multiple time instances, a second group of uplink (UL) RSs at multiple time instances, or a third group of UL transmissions at multiple time instances upon reception of a fourth group of DL transmissions at multiple time instances;
   transmit a second signal indicating to report at least one of: a first value associated with reception time instances of the first group of DL RSs, a second value associated with transmission time instances of the second group of UL RSs, or a third value associated with transmission time instances of the third group of UL transmissions; and
   receive from another apparatus at least one of the first value, the second value, or the third value, or determine the uplink reception time instances for the second group of UL RSs or for the third group of UL transmissions.

Embodiment 27: The apparatus of Embodiment 26, wherein the processor is further configured to transmit the first group of DL RSs, and wherein the first value is calculated based on a DL RS subset within the first group of DL RSs.

Embodiment 28: The apparatus of Embodiment 27, wherein the DL RS subset is configured.

Embodiment 29: The apparatus of Embodiment 27, wherein the processor is further configured to receive an index of at least one DL RS of the DL RS subset.

Embodiment 30: The apparatus of Embodiment 26, wherein the first value is based on UTC reception time instances of the first group of DL RSs or based on slot/symbol indexes of the first group of DL RSs.

Embodiment 31: The apparatus of Embodiment 27, wherein the first value is calculated by excluding a preconfigured transmission time difference of DL RSs in the DL RS subset.

Embodiment 32: The apparatus of Embodiment 26, wherein the processor is further configured to receive a UL RS subset, and wherein the second value is calculated based on the differences between the transmission time instances of UL RSs of the UL RS subset, and wherein the UL RS subset is within the second group of UL RSS.

Embodiment 33: The apparatus of Embodiment 32, wherein the second value is based on UTC transmission time instances of the UL RSs of the UL RS subset or based on slot/symbol indexes of the UL RSs of the UL RS subset.

Embodiment 34: The apparatus of Embodiment 32, wherein the second value is determined by excluding a preconfigured transmission time difference of the UL RSs in the UL RS subset.

Embodiment 35: The apparatus of Embodiment 26, wherein the third value is configured or determined based on at least one timing advance (TA) for the third group of UL transmissions.

Embodiment 36: The UE of Embodiment 35, wherein the at least one TA is based on a predetermined time domain offset between the receptions of the fourth group of DL transmissions and transmissions of the third group of UL transmissions.

Embodiment 37: The apparatus of Embodiment 35, wherein the at least one TA is 0.

Embodiment 38: The apparatus of Embodiment 35, wherein the processor is further configured to receive one TA for each of the third group of UL transmissions.

Embodiment 39: The apparatus of Embodiment 38, wherein the at least one TA is a differential TA value with respect to a reference TA, or an absolute value.

Embodiment 40: The apparatus of Embodiment 35, wherein one TA is received in the corresponding one UL transmission.

Embodiment 41: The apparatus of Embodiment 35, wherein the at least one TA is received after the last UL transmission of the third group of UL transmissions is received.

Embodiment 42: The apparatus of Embodiment 35, wherein the processor is further configured to transmit a third indication indicating a report of the at least one TA.

Embodiment 43: The apparatus of Embodiment 42, wherein the at least one TA for a number of pairs of DL transmission and UL transmissions is received, the time instances of DL transmission and UL transmissions are the latest ones prior to the transmission of the third indication.

Embodiment 44: A method performed by an apparatus, comprising:
receiving a first signal indicating at least one of: a first group of downlink (DL) reference signals (RSS) at multiple time instances, a second group of uplink (UL) RSs at multiple time instances, or a third group of UL transmissions at multiple time instances upon receptions of a fourth group of DL transmissions at multiple time instances;
receiving a second signal indicating to report at least one of: a first value associated with reception time instances of the first group of DL RSs, a second value associated with transmission time instances of the second group of UL RSs, or a third value associated with transmission time instances of the third group of UL transmissions; and
reporting at least one of the first value, the second value, or the third value or determining the uplink transmission time instances for the second group of UL RS or for the third group of UL transmission.

Embodiment 45: The method of Embodiment 44, further comprising: further:
determining a DL RS subset based on the first signal; and
calculating the first value based on the DL RS subset,
wherein the DL RS subset is selected from the first group of DL RSs, and the first value is calculated based on the differences between reception time instances of DL RSs of the DL RS subset.

Embodiment 46: The method of Embodiment 45, wherein the DL RS subset is configured.

Embodiment 47: The method of Embodiment 45, wherein the DL RS subset is based on the reception times of the first group of DL RSs.

Embodiment 48: The method of Embodiment 47, further comprising dividing the first group of DL RSs into multiple subgroups based on transmission time instances of the first group of DL RSs.

Embodiment 49: The method of Embodiment 48, further comprising assigning a first DL RS of one of the subgroups as a reference DL RS of the DL RS subset.

Embodiment 50: The method of Embodiment 47, further comprising determining a last DL RS of the DL RS subset based on reporting time instance of the first value and a first predetermined or configured threshold.

Embodiment 51: The method of Embodiment 47, further comprising reporting an index of at least one DL RS of the DL RS subset.

Embodiment 52: The method of Embodiment 44, wherein the first value is calculated based on UTC reception time instances of the first group of DL RSs or based on slot/symbol indexes of the first group of DL RSs

Embodiment 53: The method of Embodiment 45, wherein the first value is calculated by excluding a preconfigured transmission time difference of DL RSs in the DL RS subset.

Embodiment 54: The method of Embodiment 44, further comprising:
determining a UL RS subset based on the first signal; and
calculating the second value based on the UL RS subset,
wherein the UL RS subset is selected from the second group of UL RSs, and the second value is calculated based on the differences between the transmission time instances of UL RSs of the UL RS subset.

Embodiment 55: The method of Embodiment 54, wherein the second value is calculated based on UTC transmission time instances of the UL RSs of the UL RS subset or based on slot/symbol indexes of the UL RSs of the UL RS subset.

Embodiment 56: The method of Embodiment 54, wherein the second value is determined by excluding a preconfigured transmission time difference of UL RSs in the UL RS subset.

Embodiment 57: The method of Embodiment 54, wherein each UL RSs of the UL RS subset is configured or determined based on reporting time instance for the second value.

Embodiment 58: The method of Embodiment 54, further comprising dividing the second group of UL RSs into multiple subgroups based on the transmission time instances of the second group of UL RSs.

Embodiment 59: The method of Embodiment 58, further comprising determining a first UL RS of one of the subgroups as a reference UL RS of the UL RS subset.

Embodiment 60: The method of Embodiment 44, further comprising determining the third value based on at least one timing advance (TA) for the third group of UL transmissions.

Embodiment 61: The method of Embodiment 60, wherein the at least one TA is based on a predetermined time domain offset between the receptions of the fourth group of DL transmissions and transmissions of the third group of UL transmissions.

Embodiment 62: The method of Embodiment 60, wherein the at least one TA is 0.

Embodiment 63: The method of Embodiment 60, further comprising reporting one TA for each of the third group of UL transmissions.

Embodiment 64: The method of Embodiment 63, wherein the at least one TA is a differential TA value with respect to a reference TA, or an absolute value.

Embodiment 65: The method of Embodiment 60, wherein one TA is reported in the corresponding one UL transmission.

Embodiment 66: The method of Embodiment 60, wherein the at least one TA is reported after the last UL transmission of the third group of UL transmissions.

Embodiment 67: The method of Embodiment 60, wherein the at least one TA is reported based on a third indication from another apparatus.

Embodiment 68: The method of Embodiment 67, wherein the at least one TA for a number of pairs of DL transmission and UL transmission is reported, and the time instances of DL transmission and UL transmissions are the latest ones prior to the receipt of the third indication.

Embodiment 69: A method performed by an apparatus, comprising:
transmitting a first signal indicating at least one of: a first group of downlink (DL) reference signals (RSs) at multiple time instances, a second group of uplink (UL) RSs at multiple time instances, or a third group of UL transmissions at multiple time instances upon receptions of a fourth group of DL transmissions at multiple time instances;
transmitting a second signal indicating to report at least one of: a first value associated with reception time instances of the first group of DL RSs, a second value associated with transmission time instances of the second group of UL RSs, or a third value associated with transmission time instances the third group of UL transmissions; and
receiving from an apparatus at least one of the first value, the second value, or the third value, or the third value, or determining the uplink reception time instances for the second group of UL RSs or for the third group of UL transmissions.

Embodiment 70: The method of Embodiment 69, further comprising transmitting the first group of DL RSs, and wherein the first value is calculated based on a DL RS subset within the first group of DL RSs.

Embodiment 71: The method of Embodiment 70, wherein the DL RS subset is configured.

Embodiment 72: The method of Embodiment 70, further comprising receiving an index of at least one DL RS of the DL RS subset.

Embodiment 73: The method of Embodiment 69, wherein the first value is based on UTC reception time instances of the first group of DL RSs or based on slot/symbol indexes of the first group of DL RSs.

Embodiment 74: The method of Embodiment 70, wherein the first value is calculated by excluding a preconfigured transmission time difference of DL RSs in the DL RS subset.

Embodiment 75: The method of Embodiment 69, further comprising receiving a UL RS subset, wherein the second value is calculated based on the differences between the transmission time instances of UL RSs of the UL RS subset, and wherein the UL RS subset is within the second group of UL RSs.

Embodiment 76: The method of Embodiment 75, wherein the second value is based on UTC transmission time instances of the UL RSs of the UL RS subset or based on slot/symbol indexes of the UL RSs of the UL RS subset.

Embodiment 77: The method of Embodiment 74, wherein the second value is determined by excluding a preconfigured transmission time difference of the UL RSs in the UL RS subset.

Embodiment 78: The method of Embodiment 69, wherein the third value is configured or determined based on at least one timing advance (TA) for the third group of UL transmissions.

Embodiment 79: The method of Embodiment 78, wherein the at least one TA is based on a predetermined time domain offset between the receptions of the fourth group of DL transmissions and transmissions of the third group of UL transmissions.

Embodiment 80: The method of Embodiment 78, wherein the at least one TA is 0.

Embodiment 81: The method of Embodiment 78, further comprising receiving one TA for each UL transmission of the third group of UL transmissions.

Embodiment 82: The method of Embodiment 81, wherein the at least one TA is a differential TA value with respect to a reference TA, or an absolute value.

Embodiment 83: The method of Embodiment 78, wherein one TA is received in the corresponding one UL transmission.

Embodiment 84: The method of Embodiment 78, wherein the at least one TA is received after the last UL transmission of the third group of UL transmissions is received.

Embodiment 85: The method of Embodiment 78, further comprising transmitting a third indication indicating a report of the at least one TA.

Embodiment 86: The method of Embodiment 85, wherein the at least one TA for a number of pairs of DL transmission and UL transmission is received, the time instances of DL transmission and UL transmission are the latest ones prior to the transmission of the third indication.

The method according to embodiments of the present disclosure can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this application. For example, an embodiment of the present disclosure provides an apparatus for connection restoring in a non-terrestrial network, including a processor and a memory. Computer programmable instructions for implementing a method for connection restoring in a non-terrestrial network are stored in the memory, and the processor is configured to perform the computer programmable instructions to implement the method for emotion recognition from speech. The method may be a method as stated above or other method according to an embodiment of the present disclosure.

An alternative embodiment preferably implements the methods according to embodiments of the present disclosure in a non-transitory, computer-readable storage medium storing computer programmable instructions. The instructions are preferably executed by computer-executable components preferably integrated with a network security system. The non-transitory, computer-readable storage medium may be stored on any suitable computer readable media such as RAMs, ROMs, flash memory, EEPROMs, optical storage devices (CD or DVD), hard drives, floppy drives, or any suitable device. The computer-executable component is preferably a processor, but the instructions may alternatively or additionally be executed by any suitable dedicated hardware device. For example, an embodiment of the present disclosure provides a non-transitory, computer-readable storage medium having computer programmable instructions stored therein. The computer programmable instructions are configured to implement a method for emotion recognition from speech as stated above or other method according to an embodiment of the present disclosure.

While this application has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the application by simply employing the elements of the independent claims. Accordingly, embodiments of the application as set forth herein are intended to be illustrative, not limiting. Various changes may be made without departing from the spirit and scope of the application.

1. An apparatus for wireless communication, comprising:
at least one memory; and
at least one processor coupled with the at least one memory and configured to cause the apparatus to:
receive a first signal indicating at least one of: a first group of downlink (DL) reference signals (RSs) at multiple time instances, a second group of uplink (UL) RSs at multiple time instances, or a third group of UL transmission at multiple time instances upon receptions of a fourth group of DL transmissions at multiple time instances;
receive a second signal indicating to report at least one of: a first value associated with reception time instances of the first group of DL RSs, a second value associated with transmission time instances of the second group of UL RSs, or a third value associated with transmission time instances of the third group of UL transmission; and
report at least one of the first value, the second value, or the third value or determine the UL transmission time instances for the second group of UL RSs or for the third group of UL transmissions.

2. The apparatus of claim 1, wherein the at least one processor is further configured to cause the apparatus to:
determine a DL RS subset based on the first signal; and
calculate the first value based on the DL RS subset,
wherein the DL RS subset is selected from the first group of DL RSs, and the first value is calculated based on the differences between reception time instances of DL RSs of the DL RS subset.

3. The apparatus of claim 2, wherein the DL RS subset is configured.

4. The apparatus of claim 2, wherein the at least one processor is further configured to cause the apparatus to divide the first group of DL RSs into multiple subgroups based on transmission time instances of the first group of DL RSs.

5. The apparatus of claim 4, wherein the at least one processor is further configured to cause the apparatus to assign a first DL RS of one of the subgroups as a reference DL RS of the DL RS subset.

6. The apparatus of claim 2, wherein the at least one processor is further configured to cause the apparatus to determine a last DL RS of the DL RS subset based on reporting time instance of the first value and a first predetermined or configured threshold.

7. The apparatus of claim 1, wherein the first value is calculated based on coordinated universal time (UTC) reception time instances of the first group of DL RSs or based on slot/symbol indexes of the first group of DL RSs.

8. The apparatus of claim 1, wherein the at least one processor is further configured to cause the apparatus to:
determine a UL RS subset based on the first signal; and
calculate the second value based on the UL RS subset,
wherein the UL RS subset is selected from the second group of UL RSs, and the second value is calculated based on the differences between the transmission time instances of UL RSs of the UL RS subset.

9. The apparatus of claim 1, wherein the at least one processor is further configured to cause the apparatus to determine the third value based on at least one timing advance (TA) for the third group of UL transmissions.

10. The apparatus of claim 9, wherein the at least one TA is based on a predetermined time domain offset between the receptions of the fourth group of DL and transmissions of the third group of UL transmissions.

11. The apparatus of claim 9, wherein the at least one TA is a differential TA value with respect to a reference T or an absolute value.

12. The apparatus of claim 9, wherein the at least one processor is configured to cause the apparatus to report one TA in a corresponding UL transmission.

13. The apparatus of claim 9, wherein the at least one processor is configured to cause the apparatus to report the at least one TA for a number of pairs of DL transmission and UL transmission, and wherein time instances of DL transmission and UL transmission are the latest time instances prior to a receipt of a third indication from another apparatus.

14. An apparatus for wireless communication, comprising:
at least one memory; and
at least one processor coupled with the at least one memory and configured to cause the apparatus to:
transmit a first signal indicating at least one of: a first group of downlink (DL) reference signals (RSs) at multiple time instances, a second group of uplink (UL) RSs at multiple time instances, or a third group of UL transmissions at multiple time instances upon reception of a fourth group of DL transmissions at multiple time instances;
transmit a second signal indicating to report at least one of: a first value associated with reception time instances of the first group of DL RSs, a second value associated with transmission time instances of the second group of UL RSs, or a third value associated with transmission time instances of the third group of UL transmissions; and
receive from another apparatus at least one of the first value, the second value, or the third value, or determine the uplink reception time instances for the second group of UL RSs or for the third group of UL transmissions.

15. A method performed by an apparatus, the method comprising:
receiving a first signal indicating at least one of: a first group of downlink (DL) reference signals (RSs) at multiple time instances, a second group of uplink (UL) RSs at multiple time instances, or a third group of UL transmissions at multiple time instances upon receptions of a fourth group of DL transmissions at multiple time instances;
receiving a second signal indicating to report at least one of: a first value associated with reception time instances of the first group of DL RSs, a second value associated with transmission time instances of the second group of UL RSs, or a third value associated with transmission time instances of the third group of UL transmissions; and
reporting at least one of the first value, the second value, or the third value or determining the uplink transmission time instances for the second group of UL RS or for the third group of UL transmission.

16. The method of claim 15, further comprising determining the value associated with the transmission time instances of the group of UL transmissions based on at least one timing advance (TA) for the group of UL transmissions.

17. The method of claim 16, wherein the at least one TA is based on a predetermined time domain offset between the reception of the group of DL and transmissions of the group of UL transmissions.

18. The method of claim 16, wherein the at least one TA is a differential TA value with respect to a reference TA or an absolute value.

19. The method of claim 16, wherein reporting the value associated with transmission time instances of the group of UL transmissions includes reporting one TA in a corresponding UL transmission.

20. A user equipment (UE) for wireless communication, comprising:
at least one memory; and
at least one processor coupled with the at least one memory and configured to cause the apparatus to:
receive a first signal indicating at least one of:
a first group of downlink (DL) reference signals (RSs) at multiple time instances,
a second group of uplink (UL) RSs at multiple time instances, or
a third group of UL transmission at multiple time instances upon receptions of a fourth group of DL transmissions at multiple time instances;
receive a second signal indicating to report at least one of:
a first value associated with reception time instances of the first group of DL RSS,
a second value associated with transmission time instances of the second group of UL RSs, or
a third value associated with transmission time instances of the third group of UL transmission; and
report at least one of the first value, the second value, or the third value or determine the UL transmission time instances for the second group of UL RSs or for the third group of UL transmissions.
